(19) United States
(12) Patent Application Publication
(10) Pub. No.: US 2011/0145902 A1
(43) Pub. Date: Jun. 16, 2011

(54) SYSTEM AND METHOD FOR PROVIDING SEAMLESS ON-DEMAND APPLICATION SERVICE USING DPI IN COMMUNICATION NETWORKS

(75) Inventors: Eun Joo KIM, Seoul (KR); Yool Kwon, Incheon (KR); Young Boo Kim, Gongju (KR)

(73) Assignee: Electronics and Telecommunications Research Institute, Daejeon (KR)

(21) Appl. No.: 12/882,717

(22) Filed: Sep. 15, 2010

(30) Foreign Application Priority Data
Dec. 15, 2009 (KR) 10-2009-0124645

(51) Int. Cl. G06F 21/20

(52) U.S. Cl. 726/7

(57) ABSTRACT

Provided is a system and method of providing a seamless on-demand service using a Deep Packet Inspection (DPI) function. A system for providing an on-demand service may include: a switch to recognize a signature of media, and to convert a resolution of media based on information associated with a resolution of media included in the recognized signature, a terminal resolution of a terminal held by a user, and a user requirement; an authentication management server to perform a terminal authentication or a user authentication; and a policy control server to set a path based on a terminal function, a media characteristic, and the user requirement.

### CROSS-REFERENCE TO RELATED APPLICATION

This application claims the benefit of Korean Patent Application No. 10-2009-0124645, filed on Dec. 15, 2009, in the Korean Intellectual Property Office, the disclosure of which is incorporated herein by reference.

### BACKGROUND

1. Field of the Invention

The present invention relates to a system and method of providing a seamless on-demand service in a communication network, and more particularly, to a system and method that may change a resolution of media based on a terminal function, a network situation, or a user requirement, and thereby provide an on-demand service in real time.

2. Description of the Related Art

Generally, when providing contents in an environment where broadcasting and a communication are converged, there is a need to provide an optimal service in various network environments and various terminals. In this instance, a Scalable Video Coding (SVC) scheme may contain images of different resolutions in a single bitstream and thus may effectively support, using the single bitstream, various network terminals such as a mobile phone, a personal digital assistant (PDA), a personal computer (PC), a Digital Multimedia Broadcasting (DMB), an Internet Protocol Television (IPTV), and the like. However, when a single bitstream contains an image of each resolution, the SVC scheme may not provide a service with respect to a wireless terminal due to a limit of a communication bandwidth.

A scheme of providing contents to be suitable for various types of terminals may transmit multiple resolutions of media using an SVC. However, with respect to the wireless terminal, the above scheme may not provide various types of services according to a class of media to be provided, for example, premium multimedia, voice, video, and the like, due to a limit of a communication bandwidth.

In the case of a two-way communication between terminals not a broadcasting, the communication may be performed using different types of terminals. In this instance, a resolution of media may be applied to a terminal based on a display size of each receiving terminal. When a resolution difference between communicating terminals is significantly large, a communication service may not be provided. For example, when a user desires to use a video telephone service, a size of a terminal may be various from a small size to a large size such as a TV. For example, in the case of a communication between a user of a TV terminal using a wired communication and a user of a mobile phone using a wireless communication, even though media having a relatively large resolution is transmitted to the user of the mobile phone via the TV terminal corresponding to a transmission side, a large capacity of media transmission may be impossible due to a bandwidth limit in a wireless communication. Accordingly, it may be difficult to provide a video telephone service between terminals.

In the case of a media transmission, a transmitting terminal may transmit media of a resolution that may be provided by the transmitting terminal. A receiving terminal may adjust the resolution of the received media to be suitable for the receiving terminal and thereby display the media. When an available resolution of the receiving terminal is significantly lower than an available resolution of the transmitting terminal, the transmitting terminal may transmit the media of a high resolution and thereby use a large portion of communication bandwidth. On the other hand, the receiving terminal may provide the media service of a low resolution suitable for the receiving terminal. In this instance, a user of the receiving terminal may be charged with a fee corresponding to a high line use.

Also, even when a user changes a terminal, a seamless service may need to be provided. In this instance, the terminal may have various resolutions. Accordingly, there is a need to effectively change a resolution of media in real time, and to change a path situation of a network according to a network type.

To provide a seamless service with respect to various types of application media, when a terminal is changed, there is a need to provide an optimal service to the changed terminal. The terminal may be changed based on a change in a resolution of media, a change in a network type, a path change according to a network situation, a terminal function, a user requirement, and the like. Accordingly, there is a desire for a method that may provide an optimal on-demand service based on the above change when transferring the media.

### SUMMARY

An aspect of the present invention provides a system and method that may verify a resolution of media, a terminal resolution, and a user requirement using a Deep Packet Inspection (DPI) function and thereby may transfer media of an optimal resolution based on the verified resolution of media, the terminal resolution, the user requirement, a terminal function, and a network situation.

According to an aspect of the present invention, there is provided a system for providing an on-demand service, including: a switch to recognize a signature of media, and to convert a resolution of media based on information associated with a resolution of media included in the recognized signature, a terminal resolution of a terminal held by a user, and a user requirement; an authentication management server to perform a terminal authentication or a user authentication; and a policy control server to set a path based on a terminal function, a media characteristic, and the user requirement.

The switch may have a capability of processing a payload of an Internet Protocol (IP) packet, and may include a DPI processor to analyze the signature of media and convert the resolution of media according to an application service.

The switch may authenticate the terminal or the user, detect a signature of media data, measure a transmission amount of the media data, and convert the resolution of media to be suitable for a receiving terminal.

The authentication management server may include a terminal, authentication information list and a user authentication information list, and perform an authentication management using the terminal authentication information list and the user authentication information list.

The system may further include a charge management server to manage charge information. The switch may transmit user information and the charge information to the charge management server after terminating an application service.

The policy control server may store DPI information, transfer the stored DPI information to the switch, set an application media service path based on a terminal function using media passing through the switch, a media characteristic, and the user requirement, transfer information associated with the set application media service path to the switch, and transmit, to the charge management server, charge information associated with a media class and a path set.

According to another aspect of the present invention, there is provided a method of providing an on-demand service, including: processing, by a switch, an authentication using a terminal authentication information list when a terminal authentication request is received; processing, by the switch, an authentication with respect to an existing service user using a user authentication information list; recognizing, by the switch, a signature in a payload of media data transmitted using a DPI processor to verify resolution information of at least two terminals using a corresponding service; comparing, by the switch, the verified resolution information to convert a resolution of media to a lowest resolution; and providing, by the switch, a seamless on-demand service using path information transferred from a policy control server.

The method may further include: measurement, by the switch, a media data transmission amount; and cutting off, by the switch, disallowed media by recognizing the signature using the DPI processor, or by recognizing a pattern of an image content.

The method may further include informing the authentication management server that the authentication fails when a terminal authentication or a user authentication fails.

The method may further include: storing, by the policy control server, DPI information to transfer the DPI information to the switch; setting, by the policy control server, an application media service path based on a terminal function using media passing through the switch, a media characteristic, and a user requirement; transferring, by the policy control server, the set application media service path to the switch; and transmitting, by the policy control server, a class of application media and charge information associated with a path set to the charge management server.

The method may further include transmitting, by the switch, user information and the measured media data transmission amount to the charge management server after terminating a service.

### EFFECT

According to embodiments of the present invention, when a change of a terminal is needed to provide a seamless application service in a communication network, it is possible to transmit media of an optimal resolution in real time.

Also, according to embodiments of the present invention, it is possible to obtain information associated with a terminal function, a media characteristic, and a user requirement, using a Deep Packet Inspection (DPI) technology of a switch. In addition, it is possible to provide a user with a seamless optimal on-demand service by converting a resolution of media to be optimal based on the obtained information, and by setting a path based on information obtained by a policy control server and a network situation.

Also, according to embodiments of the present invention, a change of media information according to a change of a terminal may be performed by a switch instead of another server. Accordingly, it is possible to quickly transmit media. Since a terminal authentication and a user authentication may be individually performed, a user may use a service at various terminals without being subject to a terminal owner.

Also, according to embodiments of the present invention, it is possible to provide a service by perform only a user authentication in an unauthenticated terminal according to a network provider policy.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a network employing various terminals for a seamless application service according to an embodiment of the present invention;

FIG. 2 is a diagram illustrating a configuration of a network for providing a seamless on-demand service when a user desires to change a terminal while using an application service;

FIG. 3 is a diagram illustrating a communication network including management servers connected to a switch employing a Deep Packet Inspection (DPI) technology according to an embodiment of the present invention;

FIG. 4 is a diagram illustrating an Internet Protocol (IP) packet format including a signature and control information according to an embodiment of the present invention;

FIGS. 5 and 6 are flowcharts illustrating a process of converting a resolution of media when providing a service on a switch side according to an embodiment of the present invention; and

FIGS. 7 and 8 are flowcharts illustrating a control process when changing a terminal while using a service on a user terminal side according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, a system and method of providing a seamless on-demand service using a Deep Packet Inspection (DPI) function according to an embodiment of the present invention will be described with reference to the accompanying drawings.

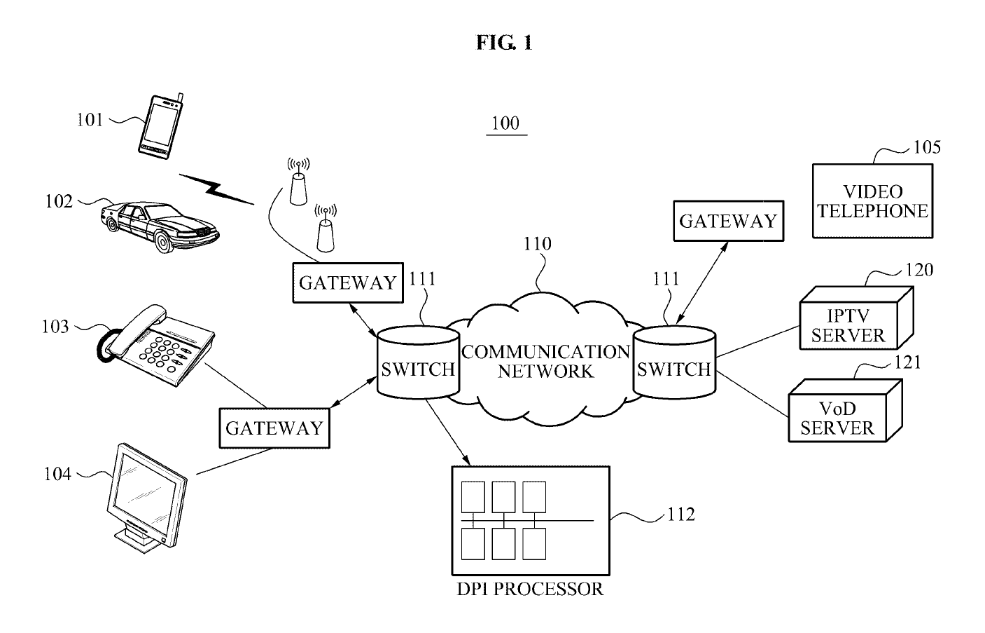

FIG. 1 is a diagram illustrating a configuration of a network employing various terminals for a seamless application service according to an embodiment of the present invention.

Referring to FIG. 1, a network structure 100 for the seamless application service may include various terminals, for example, a mobile phone 101, a car 102 installed with a mobile terminal, a wired terminal 103, a television (TV) 104, and a video telephone 105, a communication network 110, a switch 111, an Internet Protocol television (IPTV) server 120, a Video on Demand (VoD) server 121, and a DPI processor 112.

In the communication network 110, the seamless application service may be provided using various terminals such as the mobile phone 101, the car 102 installed with the mobile terminal, the wired terminal 103, the TV 104, and the video telephone 105. A quality management of the application service may enable providing of a premium service using the DPI processor 112.

The switch 111 may include the DPI processor 112. The DPI processor 112 may have a capability of processing a payload of an Internet Protocol (IP) packet, and may analyze a signature and convert an image according to the application service.

As described above, according to an embodiment of the present invention, when using voice, an image, data, wireless communication, contents information, and the like from all the terminals employing an IP address including the corresponding mobile terminal, an application service providing system may provide the seamless application service using a DPI function.

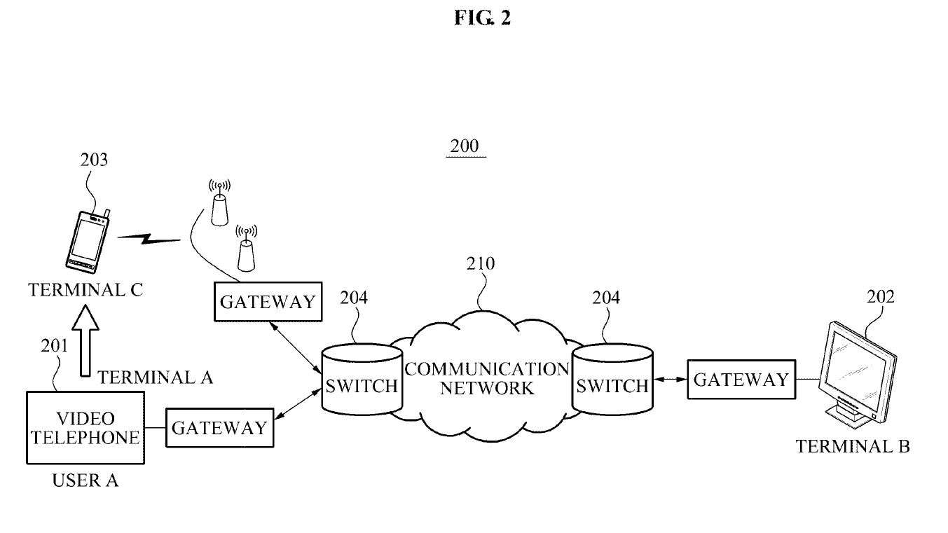

FIG. 2 is a diagram illustrating a configuration of a network for providing a seamless on-demand service when a user desires to change a terminal while using an application service.

Referring to FIG. 2, to provide the seamless on-demand service when the user desires to change a user terminal while using the application service, a network structure 200 may include a terminal A 201, a terminal B 202, a terminal C 203, a switch 204, and a communication network 210.

For example, when a video telephone service is used between a user A using the terminal A 201, for example, a PC at home and a user B using the terminal B 202, for example, a TV, the terminal A 201 may receive media of a high resolution, convert the high resolution of media to be suitable for the terminal A 201, and then display the media of the converted resolution. In this instance, the resolution conversion may be performed by the switch 204. The switch 204 may be sufficiently communicable without a conversion function of image media.

When the user A desires to continuously use a service while changing the terminal from the terminal A 201 to the terminal C 203, the terminal C 203 may have a limited wireless network resource in receiving the media of the high resolution from the terminal B 202. Specifically, the switch 204 may operate to prevent the video telephone service between the terminal B 202 and the terminal C 203 from being impossible due to a bandwidth limit. In this instance, the switch 204 may convert the high resolution of media to be low according to a characteristic of the terminal C 203 and thereby transmit the media to the terminal C 203. Accordingly, with a use of a small bandwidth, it is possible to provide the video telephone service between the terminal B 202 and the terminal C 203.

As another example, when the user A desires to change the terminal from the terminal A 201 to the terminal C 203 that is a video telephone terminal of the user A's friend, the user A needs to receive a terminal authentication of the terminal C 203 and then receive a user authentication for receiving a service using the terminal C 203. In this instance, the terminal authentication may not be provided depending on a provider policy. A user authentication scheme may request a corresponding authentication by simply inputting a user authentication number via a terminal. Also, the user may select a terminal resolution, or may request a quality of service (QoS) and the like to be suitable for the user's requirement. In the case of a terminal authentication, resolution information associated with a corresponding terminal may be transmitted to the switch 204 and thereby be stored in the switch 204. When a change in a resolution of media and the like occurs due to a change of a service providing terminal, the above information may be included in a payload of media and thereby be transmitted, and be detected via a DPI processor (not shown) of the switch 204.

As described above, according to an embodiment of the present invention, a change of media information according to a terminal change may be performed in the switch 204 instead of another server. Therefore, an application service providing system may quickly transmit the media. In addition, a terminal authentication and a user authentication may be individually performed, and thus a user may use a service at various terminals without being subject to a terminal owner.

The switch 204 may include the DPI processor and thus, may have a capability of processing a payload of data using a DPI function when transmitting various types of application media. The switch 204 may sense a signature of data to thereby extract media resolution information and convert a resolution of media based on the extracted information. The switch 204 may measure an application media data transmission amount, and include path information transferred from a policy control server (not shown).

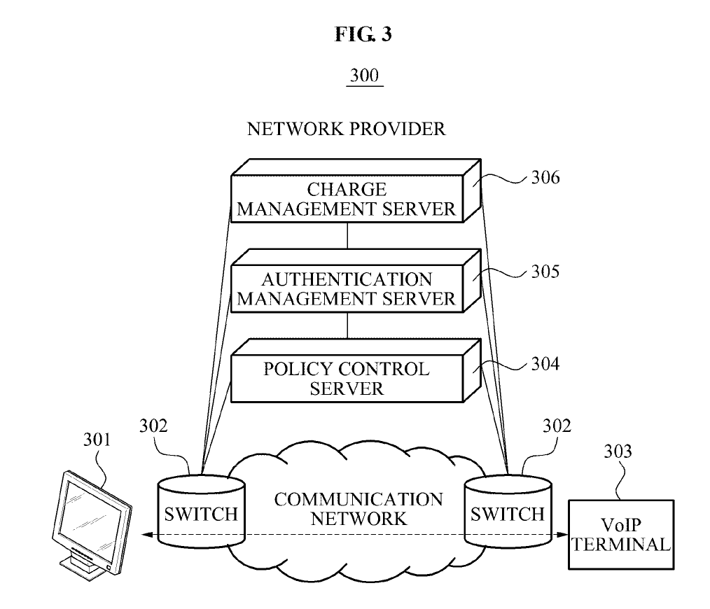

FIG. 3 is a diagram illustrating a communication network including management servers connected to a switch employing a DPI technology according to an embodiment of the present invention.

Referring to FIG. 3, a communication network structure 300 may include terminals 301 and 303, a switch 302, a policy control server 304, an authentication management server 305, and a charge management server 306.

When the terminal 301 is switched on and requests a terminal authentication, the switch 302 may perform the terminal authentication using a terminal authentication information list stored in the switch 302.

When the terminal authentication is completed, a user authentication with respect to the terminal 301 may need to be performed. When a user of the terminal 301 corresponds to an existing user, the user may be authenticated using user authentication information stored in the switch 302. An initial user of a corresponding service may be authenticated by the authentication management server 305, and authentication information stored in the authentication management server 305 may be transferred to the switch 302.

When the user authentication is completed, the switch 302 may transmit, to the authentication management server 305, information associated with the changed terminal 301 and the user. The authentication management server 305 may manage information associated with the authenticated user. Specifically, the authentication management server 305 may have a terminal authentication information list and a user authentication information list, and may perform an authentication management using the terminal authentication information list and the user authentication information list.

When the terminal authentication and the user authentication are completed, the switch 302 may detect a data signature using a DPI function. In this instance, the switch 302 may recognize a resolution of media and recognize a terminal resolution by detecting packet control information. The switch 302 may transmit data of which a resolution is adjusted to a lower resolution between a resolution of the terminal 301 corresponding to a transmitting terminal and a resolution of the terminal 303, for example, a Voice over Internet Protocol (VoIP) terminal corresponding to a receiving terminal. The switch 302 may measure a data transmission amount. In the case of a wired communication, a communication may be sufficiently performed even without a function of converting a resolution of media. However, in the case of the wireless communication, a conversion of a resolution may be an important issue.

With respect to a provided service, the user may also request a terminal resolution, a media class, and the like. For example, when a plurality of resolutions or media classes are provided in a corresponding terminal, the user may select the user's desired resolution or media class.

The switch 302 may convert the resolution of media based on the resolution of media, the terminal resolution, and QoS information newly required by the user. The switch 302 may transfer, to the policy control server 304, packet control information, for example, the terminal resolution and the user requirement, and signature information obtained using the DPI function.

The policy control server 304 may newly configure path information based on a change in a wired/wireless network type that may occur due to a change of a service providing terminal, a change of a path according to a network name, a user requirement, and a change of a resolution, and then transfer the newly configured path information to the switch 302. The policy control server 304 may store DPI information, and may transfer the stored DPI information to the switch 302. Specifically, the policy control server 304 may store the DPI information, transfer the stored DPI information to the switch 302, and set an application media service path based on a terminal function used by media passing through the switch, a media characteristic, and the user requirement.

After terminating an application service, the switch 302 may transmit, to the charge management server 306, charge information such as user information and the measured data transmission amount.

The policy control server 304 may transfer information associated with the set application media service path to the switch 302, and may transmit charge information associated with a media class and a set path to the charge management server 306.

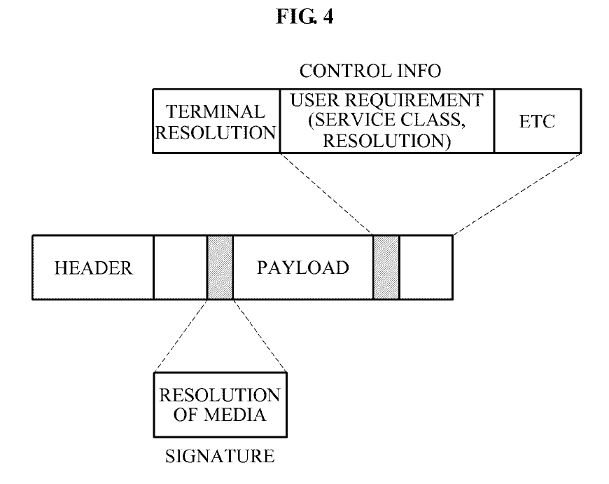

FIG. 4 is a diagram illustrating an IP packet format including a signature and control information according to an embodiment of the present invention.

Referring to FIGS. 1 and 4, the DPI processor 112 may have a function of processing a payload of an IP packet, and the signature and the control information may be included in the payload. The signature may include resolution information of image media. The control information may include a resolution of a terminal held by a user, the user's requirement, and the like. The DPI processor 112 may be additionally generated according to a DPI function, and may analyze the signature and the control information and convert an image.

When a plurality of media resolutions is provided in a terminal, it is possible to select and change a resolution based on the user's requirement. The user may request a new QoS.

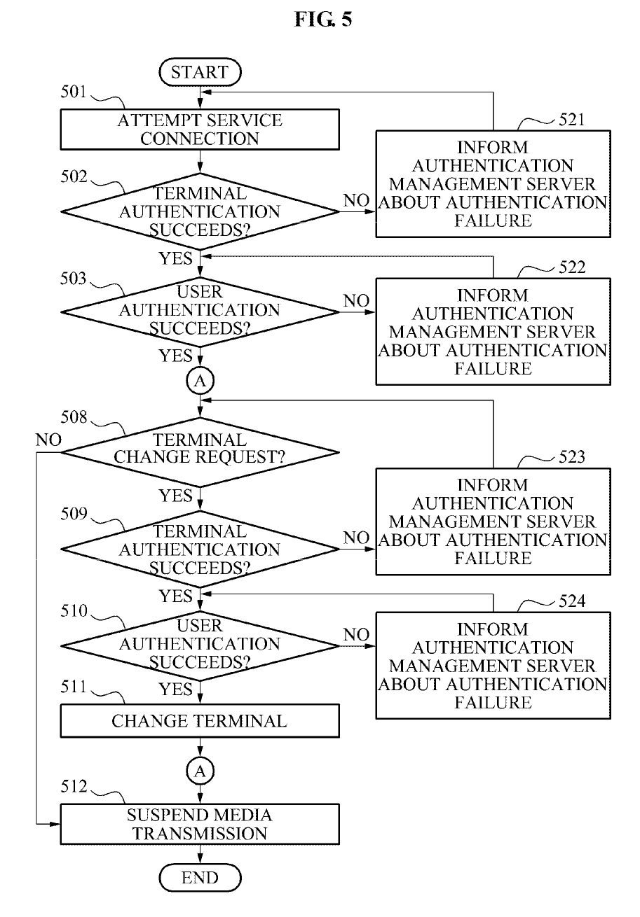

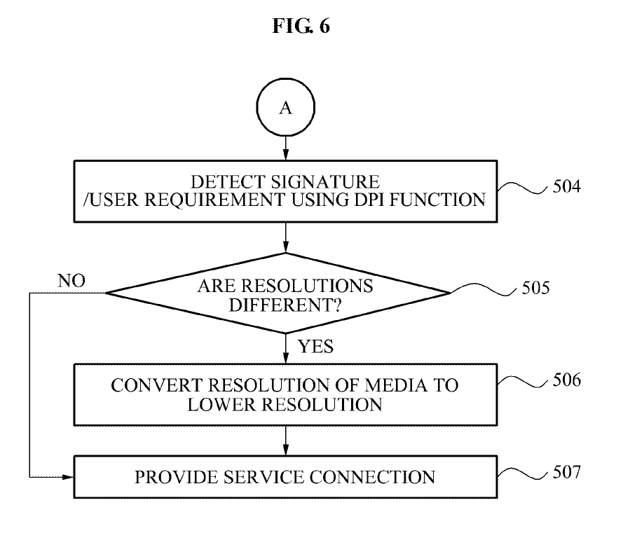

FIGS. 5 and 6 are flowcharts illustrating a process of converting a resolution of media when providing a service on a switch side according to an embodiment of the present invention.

Referring to FIGS. 5 and 6, a switch may attempt a connection to a service requested by a user terminal in operation 501, and may perform a terminal authentication requested for providing the service in operation 502. Specifically, the switch may process a terminal authentication with respect to the user terminal using a terminal authentication information list.

When authentication information associated with the user terminal does not exist in the terminal authentication information list, the switch may inform an authentication management server about a terminal authentication failure in operation 521.

When the terminal authentication is completed, the switch may perform a user authentication with respect to a user of the authenticated terminal in operation 503. Specifically, the switch may process the user authentication with respect to an existing service user using a user authentication information list.

When authentication information associated with the user of the authenticated terminal does not exist in the user authentication information list, the switch may inform the authentication management server about the user authentication failure in operation 522.

When the user authentication is completed, the switch may transmit media to the user terminal, detect a media data signature using the DPI function, detect resolution information of media, and detect control information such as a terminal resolution, a user requirement, and the like in operation 504.

In operation 505, the switch may determine whether a resolution of a transmitting terminal is different from a resolution of a receiving terminal.

When the resolution of the transmitting terminal is different from the resolution of the receiving terminal, the switch may convert a resolution of media to a lower resolution between the resolution of the transmitting terminal and the resolution of the receiving terminal in operation 506.

In operation 507, the switch may provide a service connection between the transmitting terminal and the receiving terminal.

In operation 508, the switch may determine whether a terminal change request is received from the transmitting terminal or the receiving terminal.

When the terminal change request is received, the switch may determine whether an authentication succeeds by performing a terminal authentication with respect to a terminal to be changed in operation 509. Specifically, the switch may perform the terminal authentication with respect to the terminal to be changed, using the terminal authentication information list, and may determine whether the terminal authentication succeeds.

When the terminal authentication fails, the switch may inform the authentication management server about a terminal authentication failure in operation 523.

Conversely, when the terminal authentication succeeds, the switch may perform the user authentication with respect to the terminal to be changed and thereby determine whether the user authentication succeeds in operation 510. Specifically, the switch may determine whether the user authentication succeeds depending on a result of performing the user authentication with respect to the terminal to be changed using the user authentication information list.

When the user authentication fails, the switch may inform the authentication management server about a user authentication failure in operation 524.

Conversely, when the user authentication succeeds, the switch may change a corresponding service providing terminal to the terminal to be changed in operation 511.

When the service providing terminal is changed, the switch may detect a data signature, a resolution of media, a terminal resolution, or a user requirement with respect to the changed terminal, using a DPI function in operation 504, determine whether the resolution of the transmitting terminal is different from the resolution of the receiving terminal in operation 506, convert the resolution of the corresponding terminal to a lower resolution in operation 507, and transmit media of the converted resolution, and thereby provide a service connection in operation 508.

When the service connection is provided with respect to the changed terminal, the switch may suspend a media transmission with respect to a previous terminal in operation 512.

According to an embodiment of the present invention, a method of providing an application service may provide a seamless application service based on a terminal function, a media characteristic, a network situation, or a user requirement.

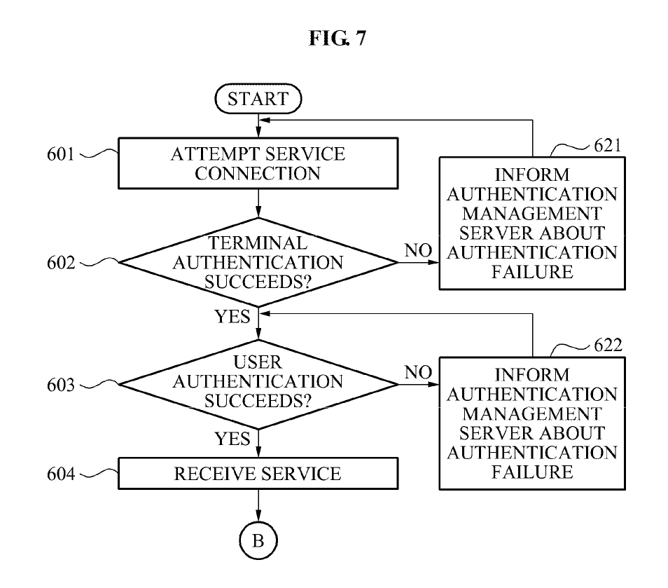

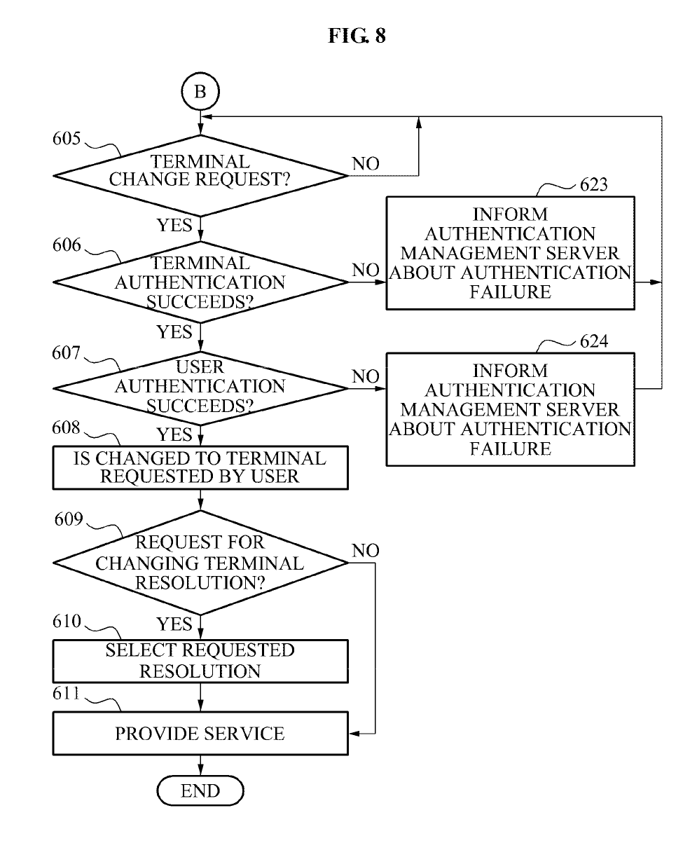

FIGS. 7 and 8 are flowcharts illustrating a control process when changing a terminal while using a service on a user terminal side.

Referring to FIGS. 7 and 8, a user terminal may attempt a service access in operation 601 and request a terminal authentication. A switch may perform the terminal authentication according to a terminal authentication request from the user terminal. When the terminal authentication fails, the switch may inform an authentication management server about a terminal authentication failure in operation 621.

In operation 602, the user terminal may determine whether the terminal authentication succeeds. When the terminal authentication succeeds, the user terminal may request a user authentication. In this instance, the switch may perform the user authentication according to a user authentication request from the user terminal. When the user authentication fails, the switch may inform the authentication management server about a user authentication failure in operation 622.

In operation 603, the user terminal may determine whether the user authentication succeeds. When the user authentication succeeds, the user terminal may receive a corresponding service from the switch in operation 604.

In operation 605, the user terminal may determine whether a terminal change request is received from the user.

When the terminal change request is received from the user, the user terminal may request the switch about an authentication of a terminal to be changed, and determine whether the authentication of the terminal to be changed succeeds in operation 606. When the authentication fails, the switch may inform the authentication management server about a terminal authentication failure in operation 623.

When the authentication succeeds, the user terminal may request the switch about the user authentication and determine whether the user authentication succeeds in operation 607. When the user authentication fails, the switch may inform the authentication management server about a user authentication failure in operation 624.

When the user authentication succeeds, the user terminal may be changed to the terminal requested by the user in operation 608.

In operation 609, the user terminal may determine whether a request for changing a terminal resolution is received from the user.

When the request is received from the user, the user terminal may select a resolution requested from the user in operation 610.

In operation 611, the user terminal may provide a continuous service of media having a resolution adjusted to be suitable for the selected resolution. A previous terminal may suspend the service.

As described above, according to an embodiment of the present invention, when a user desires to change a terminal while using a service, and in this instance, performs a terminal authentication and a user authentication with respect to a terminal to be changed and then selects a change of a terminal resolution, a method of providing an application media service may provide a continuous service of media having a resolution adjusted to be suitable for a selected resolution.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A system for providing an on-demand service, comprising:
a switch to recognize a signature of media, and to convert a resolution of media based on information associated with a resolution of media included in the recognized signature, a terminal resolution of a terminal held by a user, and a user requirement;
an authentication management server to perform a terminal authentication or a user authentication; and
a policy control server to set a path based on a terminal function, a media characteristic, and the user requirement.

2. The system of claim 1, wherein the switch has a capability of processing a payload of an Internet Protocol (IP) packet, and includes a Deep Packet Inspect (DPI) processor to analyze the signature of media and convert the resolution of media according to an application service.

3. The system of claim 1, wherein the switch authenticates the terminal or the user, detects a signature of media data, measures a transmission amount of the media data, and converts the resolution of media to be suitable for a receiving terminal.

4. The system of claim 1, wherein the authentication management server includes a terminal authentication information list and a user authentication information list, and performs an authentication management using the terminal authentication information list and the user authentication information list.

5. The system of claim 1, further comprising:
a charge management server to manage charge information,
wherein the switch transmits user information and the charge information to the charge management server after terminating an application service.

6. The system of claim 5, wherein the policy control server stores DPI information, transfers the stored DPI information to the switch, sets an application media service path based on a terminal function using media passing through the switch, a media characteristic, and the user requirement, transfers information associated with the set application media service path to the switch, and transmits, to the charge management server, charge information associated with a media class and a path set.

7. A method of providing an on-demand service, comprising:
processing, by a switch, an authentication using a terminal authentication information list when a terminal authentication request is received;
processing, by the switch, an authentication with respect to an existing service user using a user authentication information list;
recognizing, by the switch, a signature in a payload of media data transmitted using a DPI processor to verify resolution information of at least two terminals using a corresponding service;
comparing, by the switch, the verified resolution information to convert a resolution of media to a lowest resolution; and
providing, by the switch, a seamless on-demand service using path information transferred from a policy control server.

8. The method of claim 7, further comprising:
measurement, by the switch, a media data transmission amount; and
cutting off, by the switch, disallowed media by recognizing the signature using the DPI processor, or by recognizing a pattern of an image content.

9. The method of claim 7, further comprising:
informing the authentication management server that the authentication fails when a terminal authentication or a user authentication fails.

10. The method of claim 7, further comprising:
storing, by the policy control server, DPI information to transfer the DPI information to the switch;
setting, by the policy control server, an application media service path based on a terminal function using media passing through the switch, a media characteristic, and a user requirement;
transferring, by the policy control server, the set application media service path to the switch; and
transmitting, by the policy control server, a class of application media and charge information associated with a path set to the charge management server.

11. The method of claim 8, further comprising:
transmitting, by the switch, user information and the measured media data transmission amount to the charge management server after terminating a service.
